(19) United States
(12) Patent Application Publication
(10) Pub. No.: US 2026/0318669 A1
(43) Pub. Date: Oct. 15, 2026

(54) MULTI-MODE INTERFEROMETER AND PHOTONIC INTEGRATED CIRCUIT INCLUDING THE SAME

(71) Applicant: SAMSUNG ELECTRONICS CO., LTD., Suwon-si (KR)

(72) Inventors: Hyunsung PARK, Suwon-si (KR); Jaekwan KIM, Suwon-si (KR); Subeom SONG, Suwon-si (KR); Sungmo AHN, Suwon-si (KR); Suyeon LEE, Suwon-si (KR); Junho LEE, Suwon-si (KR); Choonlae CHO, Suwon-si (KR); Sookyoung ROH, Suwon-si (KR); Sangeun MUN, Suwon-si (KR)

(73) Assignee: SAMSUNG ELECTRONICS CO., LTD., Suwon-si (KR)

(21) Appl. No.: 19/461,105

(22) Filed: Jan. 27, 2026

(30) Foreign Application Priority Data
Feb. 10, 2025 (KR) 10-2025-0016963

(51) Int. Cl. G01B 9/02015

(52) U.S. Cl. CPC G01B 9/02027

(57) ABSTRACT

A multi-mode interferometer includes an input portion, an output portion, and a multi-mode interference region connected between the input portion and the output portion, where the multi-mode interference region may include at least one cavity corresponding to at least one of the input portion and the output portion. The at least one cavity is provided in a region adjacent to at least one of the input portion and the output portion.

### CROSS-REFERENCE TO RELATED APPLICATION

This application is based on and claims priority under 35 U.S.C. § 119 to Korean Patent Application No. 10-2025-0016963, filed on Feb. 10, 2025, in the Korean Intellectual Property Office, the disclosure of which is incorporated by reference herein in its entirety.

### BACKGROUND

### 1. Field

The disclosure relates to a multi-mode interferometer and a photonic integrated circuit including the multi-mode interferometer.

### 2. Description of Related Art

In optical systems, multi-mode interferometers (MMIs) are widely used as key components for distributing or combining light among multiple input and output channels. In general, such an MMI may be designed in a tetragonal shape, and in this case, the amount of light delivered to each output channel may be controlled by adjusting the length of the MMI (in the propagation direction of light) and the width of the MMI (in a direction perpendicular to the propagation direction). Accordingly, optical signals may be distributed according to the intended purpose.

In related art, characteristics of light distribution to multiple channels are controlled through structural design of MMIs. This method enables light distribution based on a relatively simple structure, but has a fundamental limitation in precisely controlling the distribution of light when a large number of output channels are present. Therefore, new design and technical approaches are required for more precisely controlling the distribution of light to output channels.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided are a multi-mode interferometer and a photonic integrated circuit including the multi-mode interferometer.

Additional aspects will be set forth in part in the description which follows and, in part, will be apparent from the description, or may be learned by practice of the presented embodiments of the disclosure.

According to an aspect of the disclosure, a multi-mode interferometer may include an input portion, an output portion, and a multi-mode interference region connected between the input portion and the output portion, where the multi-mode interference region may include at least one cavity corresponding to at least one of the input portion and the output portion.

The input portion may include at least one input waveguide, the at least one cavity may be adjacent to the input portion, and the at least one cavity may be spaced apart from a central axis of the at least one input waveguide.

The input portion may include a plurality of input waveguides, the at least one cavity may be adjacent to the input portion, and the at least one cavity may be between central axes of adjacent input waveguides among the plurality of input waveguides.

The output portion may include at least one output waveguide, the at least one cavity may be adjacent to the output portion, and the at least one cavity may be spaced apart from a central axis of the at least one output waveguide.

The output portion may include a plurality of output waveguides, the at least one cavity may be adjacent to the output portion, and the at least one cavity may be between central axes of adjacent output waveguides among the plurality of output waveguides.

The multi-mode interference region may extend in a first direction, and a width of the multi-mode interference region in a second direction perpendicular to the first direction may vary along the first direction.

The input portion may include at least one input waveguide, and the output portion may include at least one output waveguide, and at least one of the at least one input waveguide and the at least one output waveguide may include a tapered structure.

The input portion may include at least one input waveguide, and the output portion may include at least one output waveguide, and a number of the at least one input waveguide is equal to a number of the at least one output waveguide.

The input portion may include at least one input waveguide, and the output portion may include at least one output waveguide, and a number of the at least one input waveguide is different from a number of the at least one output waveguide.

The output portion may include a plurality of output waveguides, and intensities of output light coupled to the plurality of output waveguides may be the same.

The output portion may include a plurality of output waveguides, and intensities of output light coupled to the plurality of output waveguides may be different.

The output portion may include a plurality of output waveguides, and wavelengths of output light coupled to the plurality of output waveguides may be the same.

The output portion may include a plurality of output waveguides, and wavelengths of output light coupled to the plurality of output waveguides may be different.

The multi-mode interference region may include at least one of silicon and silicon nitride.

The multi-mode interferometer may include a lower cladding and an upper cladding, where the multi-mode interference region may be on the lower cladding, the lower cladding may include silicon oxide, the upper cladding may be on the multi-mode interference region, and the upper cladding may include silicon oxide.

According to an aspect of the disclosure, a photonic integrated circuit may include a light source configured to emit light, a multi-mode interferometer configured to transmit light from the light source, and a photodetector configured to convert the light transmitted through the multi-mode interferometer into an electrical signal, where the multi-mode interferometer may include an input portion, an output portion, and a multi-mode interference region connected between the input portion and the output portion, where the multi-mode interference region may include at least one cavity corresponding to at least one of the input portion and the output portion.

The input portion may include at least one input waveguide, the at least one cavity may be adjacent to the input portion, and the at least one cavity may be spaced apart from a central axis of the at least one input waveguide.

The input portion may include a plurality of input waveguides, the at least one cavity may be adjacent to the input portion, and the at least one cavity may be between central axes of adjacent input waveguides among the plurality of input waveguides.

The output portion may include at least one output waveguide, the at least one cavity may be adjacent to the output portion, and the at least one cavity may be spaced apart from a central axis of the at least one output waveguide.

The output portion may include a plurality of output waveguides, the at least one cavity may be adjacent to the output portion, and the at least one cavity may be between central axes of adjacent output waveguides among the plurality of output waveguides.

The multi-mode interference region may include a plurality of cavities including the at least one cavity, where the multi-mode interference region includes a first material having a first refractive index, a first cavity, among the plurality of cavities, is filled with a second material having a second refractive index, the second refractive index being less than the first refractive index, and a second cavity, among the plurality of cavities, is unfilled.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a multi-mode interferometer according to one or more embodiments;

FIG. 2 is an enlarged view illustrating an example of the multi-mode interferometer shown in FIG. 1 according to one or more embodiments;

FIG. 3 is an enlarged view illustrating another example of the multi-mode interferometer shown in FIG. 1 according to one or more embodiments;

FIG. 4 is a diagram illustrating wavelength input and output by channel in a multi-mode interferometer, according to one or more embodiments;

FIGS. 5A, 5B, 5C and 5D are graphs illustrating wavelength input and output by channel with respect to a pattern size of the multi-mode interferometer shown in FIG. 4 according to one or more embodiments;

FIGS. 6, 7 and 8 are diagrams illustrating multi-mode interferometers according to one or more embodiments.

FIG. 9 is a cross-sectional view illustrating a multi-mode interferometer according to one or more embodiments; and

FIG. 10 is a diagram schematically illustrating an example configuration of a photonic integrated circuit according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, embodiments will be described with reference to the accompanying drawings. In the drawings, like reference numerals refer to like elements, and the sizes of elements may be exaggerated for clarity of illustration. The embodiments described herein are for illustrative purposes only, and various modifications may be made therein.

It will be understood that when an element or layer is referred to as being “over,” “above,” “on,” “below,” “under,” “beneath,” “connected to” or “coupled to” another element or layer, it can be directly over, above, on, to a side, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms of a singular form may include plural forms unless otherwise mentioned. It will be further understood that the terms “comprises” and/or “comprising” used herein specify the presence of stated features or elements, but do not preclude the presence or addition of one or more other features or elements.

An element referred to with the definite article or a demonstrative determiner may be construed as the element or the elements even though it has a singular form. Operations of a method may be performed in an appropriate order unless explicitly described in terms of order or described to the contrary, and are not limited to the stated order thereof. Terms such as first, second, etc. may be used to describe various components, but are used only for the purpose of distinguishing one component from another component. These terms do not limit the difference in the material or structure of the components

In the present disclosure, terms such as “unit” or “module” may be used to denote a unit that has at least one function or operation and is implemented with hardware, software, or a combination of hardware and software.

Furthermore, line connections or connection members between elements depicted in the drawings represent functional connections and/or physical or circuit connections by way of example, and in actual applications, they may be replaced or embodied with various additional functional connections, physical connections, or circuit connections.

Examples or terms are just used herein to describe technical ideas and should not be considered for purposes of limitation unless defined by the claims.

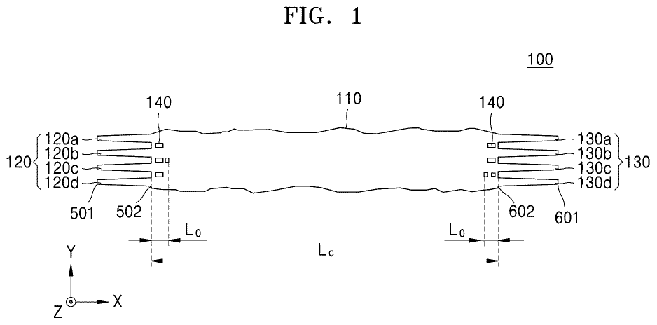

FIG. 1 is a diagram schematically illustrating a multi-mode interferometer (MMI) 100 according to one or more embodiments.

Referring to FIG. 1, the MMI 100 may include a multi-mode interference region 110, an input portion 120 through which an optical signal is input into the multi-mode interference region 110, and an output portion 130 through which an optical signal generated by the multi-mode interference region 110 is output to the outside.

The input portion 120 and the output portion 130 are spaced apart from each other in a first direction (X-direction), and the multi-mode interference region 110 may connect the input portion 120 and the output portion 130 to each other. The input portion 120 may include one or more input waveguides 120a, 120b, 120c, and 120d, and the output portion 130 may include one or more output waveguides 130a, 130b, 130c, and 130d. The input waveguides 120a, 120b, 120c, and 120d may be referred to as input ports, and the output waveguides 130a, 130b, 130c, and 130d may be referred to as output ports. The incoming light (e.g., the optical signal) may be split and guided to multiple output ports, each representing a distinct channel. In some embodiments, each channel may carry a different wavelength, enabling wavelength-division multiplexing. The one or more input waveguides 120a, 120b, 120c, and 120d and the one or more output waveguides 130a, 130b, 130c, and 130d may have a tapered structure. As an example, the one or more input waveguides 120a, 120b, 120c, and 120d and the one or more output waveguides 130a, 130b, 130c, and 130d may have a tapered structure in which the width of the waveguides in the Y-direction decreases towards ends of the multi-mode interference region 110 in the X-direction.

FIG. 1 illustrates an example in which the number of input waveguides 120a, 120b, 120c, and 120d is equal to the number of output waveguides 130a, 130b, 130c, and 130d. However, the number of input waveguides 120a, 120b, 120c, and 120d and the number of output waveguides 130a, 130b, 130c, and 130d may be different from each other.

The intensities of output light coupled to the one or more output waveguides 130a, 130b, 130c, and 130d may be equal or substantially equal (e.g., permitting minor variations) to each other. Alternatively, the intensities of output light coupled to the one or more output waveguides 130a, 130b, 130c, and 130d may be different from each other. For example, the wavelengths of output light coupled to the one or more output waveguides 130a, 130b, 130c, and 130d may be equal to each other. Alternatively, the wavelengths of output light coupled to the one or more output waveguides 130a, 130b, 130c, and 130d may be different from each other.

The multi-mode interference region 110 may include at least one cavity 140 provided in a region (or an additional region) adjacent to at least one of the input portion 120 and the output portion 130. For example, at least one cavity 140 may be provided in a region adjacent to the input portion 120, and at least one other cavity 140 may be provided in a region adjacent to the output portion 130. The number, size, and shape of the at least one cavity 140 may be arbitrary selected. The at least one cavity 140 may include a material having a refractive index that is less than that of a material included in the multi-mode interference region 110, or the at least one cavity 140 may be empty.

The at least one cavity 140 may serve as a barrier that blocks light output from the one or more input waveguides 120a, 120b, 120c, and 120d or the one or more output waveguides 130a, 130b, 130c, and 130d. In addition, the at least one cavity 140 may serve to diffract light into the multi-mode interference region 110 in a given mode.

The multi-mode interference region 110 may output, to the output portion 130, at least one optical output signal that is generated by causing an optical input signal to undergo multi-mode interference. The multi-mode interference region 110 may be formed in an arbitrary contour capable of increasing device efficiency. The multi-mode interference region 110 may have an arbitrary contour as a whole, or may have an arbitrary contour in only a portion thereof. The multi-mode interference region 110 may have, for example, a discontinuous contour in at least a portion thereof. For example, the width of the multi-mode interference region 110 may have a bumpy contour, rather than a smooth one, in at least a portion thereof. For example, in at least a part of the multi-mode interference region 110, widths of adjacent portions may discontinuously vary. In other words, the overall width of the multi-mode interference region 110 may vary along the longitudinal direction (e.g., the horizontal direction in, for example, FIG. 1). Put alternatively, the multi-mode interference region 110 may extend in the horizontal direction, and the widths, when measured in the vertical direction that is perpendicular to the horizontal direction, may vary along the horizontal length of the multi-mode interference region 110.

The amount of an output optical signal coupled to each of the one or more output waveguides 130a, 130b, 130c, and 130d of the output portion 130 may be adjusted according to the size (for example, length or effective width) of the multi-mode interference region 110. The length of the multi-mode interference region 110 may be defined as in Equation (1).

$${L}_{c} ≅ \frac{4}{3} n \frac{{W}^{2}}{λ} + 2 {L}_{0} \qquad ( 1 )$$

In Equation (1), L_{c} refers to the length of the multi-mode interference region 110, n refers to the effective refractive index of the multi-mode interference region 110, W refers to the effective width of the multi-mode interference region 110, λ refers to the wavelength of light, and L₀ refers to the length of an additional region for compensating for a wavelength shift caused by process error. The additional region may be provided in a region adjacent to the input portion 120 or the output portion 130. The at least one cavity 140 may be provided in the additional region.

For example, the length L₀ of the additional region may refer to a length from a cavity 140 provided near the center of the multi-mode interference region 110 among cavities 140 arranged adjacent to the one or more input waveguides 120a, 120b, 120c, and 120d, to an end of the multi-mode interference region 110 connected to the input portion 120. Alternatively, the length L₀ of the additional region may refer to a length from a cavity 140 provided near the center of the multi-mode interference region 110 among cavities 140 arranged adjacent to the one or more output waveguides 130a, 130b, 130c, and 130d, to the other end of the multi-mode interference region 110 connected to the output portion 130. For example, referring to FIG. 1, input waveguide 120d may have a first end 501 and a second end 502 to which the multi-mode interference region 110 is connected, and the output waveguide 130d may have a first end 601 and a second end 602 to which the multi-mode interference region 110 is connected. Cavities 140 may be positioned in the multi-mode interference region 110 relatively adjacent to the second ends 502 and 602, and the length L₀ of the additional region may refer to the distance between the second ends 502 and 602 and the respective extension of the cavities 140 in the X-direction.

The MMI 100 of the disclosure may include the additional region in which the at least one cavity 140 is provided for compensating for a wavelength shift caused by process error. Thus, the MMI 100 may be insensitive to pattern size variations and robust against process errors.

In the MMI 100 of the disclosure, the at least one cavity 140 is provided in the multi-mode interference region 110 at a position adjacent to at least one of the input portion 120 and the output portion 130. Therefore, even when the overall pattern size of the MMI 100 becomes smaller or larger due to process errors, a decrease in the efficiency of the MMI 100 may be prevented by avoiding redshift or blueshift of the wavelength-dependent coupling efficiency spectrum of the MMI 100.

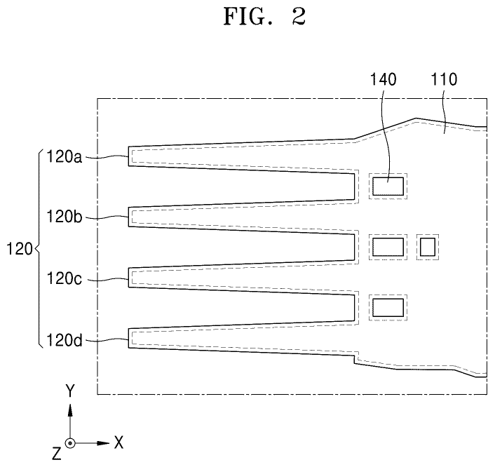

FIG. 2 is an enlarged view illustrating an example of the MMI 100 shown in FIG. 1 according to one or more embodiments.

Referring to FIG. 2, the at least one cavity 140 may be provided in the multi-mode interference region 110 at a position adjacent to the input portion 120. Although FIG. 2 illustrates an example in which the at least one cavity 140 is provided in the multi-mode interference region 110 at a position adjacent to the input portion 120, at least one other cavity 140 may also be provided in the multi-mode interference region 110 at a position adjacent to the output portion 130. The at least one cavity 140 may have, for example, a polygonal shape. For example, the at least one cavity 140 may have a tetragonal shape as shown in FIG. 2.

When the size of the multi-mode interference region 110 reduces (as shown by a dashed line), the size of the at least one cavity 140 provided in the multi-mode interference region 110 may become relatively larger (as shown by dashed lines). Therefore, even when the overall size of the MMI 100 reduces, device characteristics may be maintained by an additional region formed by the at least one cavity 140. Furthermore, even when the overall size of the MMI 100 increases, device characteristics may be maintained owing to the at least one cavity 140.

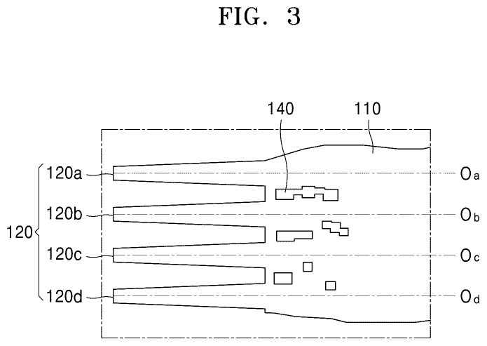

FIG. 3 is an enlarged view illustrating an example of the MMI 100 shown in FIG. 1 according to one or more embodiments.

Referring to FIG. 3, the at least one cavity 140 may have, for example, an arbitrary contour. All or some of the at least one cavity 140 may have an arbitrary contour. For example, all of the at least one cavity 140 may have an arbitrary contour, or some of the at least one cavity 140 may have a polygonal shape and others may have an arbitrary contour. The arbitrary contour may improve the efficiency of the MMI 100.

The at least one cavity 140 provided adjacent to the one or more input waveguides 120a, 120b, 120c, and 120d may be spaced apart from central axes Oₐ, O_{b}, O_{c}, and O_{d} of the one or more input waveguides 120a, 120b, 120c, and 120d. In particular, the central axes may start from a center of a waveguide as measured in a latitudinal direction and extend longitudinally along the waveguide, and the cavity may be spaced apart from this axis. As an example, and referring to FIG. 3, the central axis Oₐ of the input waveguide 120a may start from a center of the input waveguide 120a as identified based on the vertical direction and extend along the horizontal direction, while the cavity 140 may be spaced apart from the central axis Oₐ in the vertical direction (i.e., the cavities may be vertically offset from the central axes). Put alternatively, the cavity may not be overlapped by or intersected by a corresponding central axis. The reason for this is that when the at least one cavity 140 overlaps the central axes Oₐ, O_{b}, O_{c}, and O_{d} of the one or more input waveguides 120a, 120b, 120c, and 120d, light may scatter excessively, thereby reducing the efficiency of the MMI 100. Similarly, the at least one cavity 140 provided adjacent to the one or more output waveguides 130a, 130b, 130c, and 130d may be apart from central axes of the one or more output waveguides 130a, 130b, 130c, and 130d.

For example, the at least one cavity 140 may be provided between the central axes of adjacent input waveguides among the one or more input wave guides 120a, 120b, 120c, and 120d (for example, between the central axes Oₐ and O_{b}, O_{b} and O_{c}, or O_{c} and O_{d}), and the at least one cavity 140 may be provided between the central axes of adjacent output waveguides among the one or more output waveguides 130a, 130b, 130c, and 130d. The number, shape, position (for example, a relative position from the input portion 120), and size of the at least one cavity 140 provided between the central axes of the one or more input waveguides 120a, 120b, 120c, and 120d may be the same as or different from the number, shape, position (for example, a relative position from the output portion 130), and size of the at least one cavity 140 provided between the central axes of the one or more output waveguides 130a, 130b, 130c, and 130d.

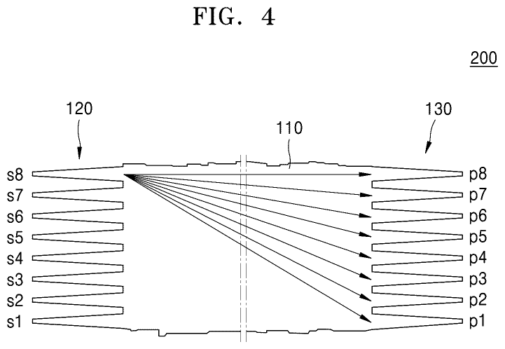

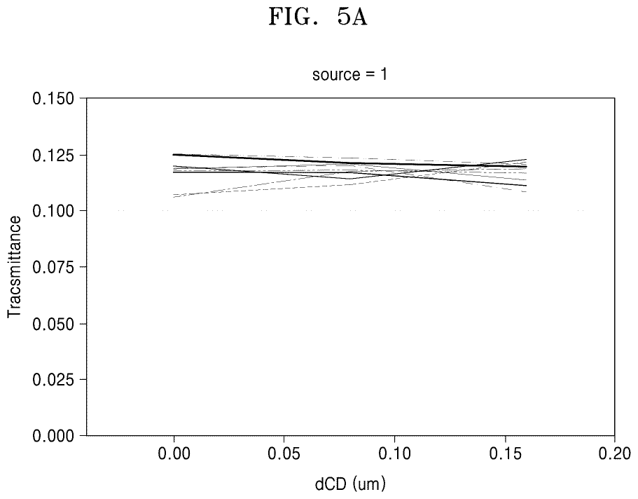

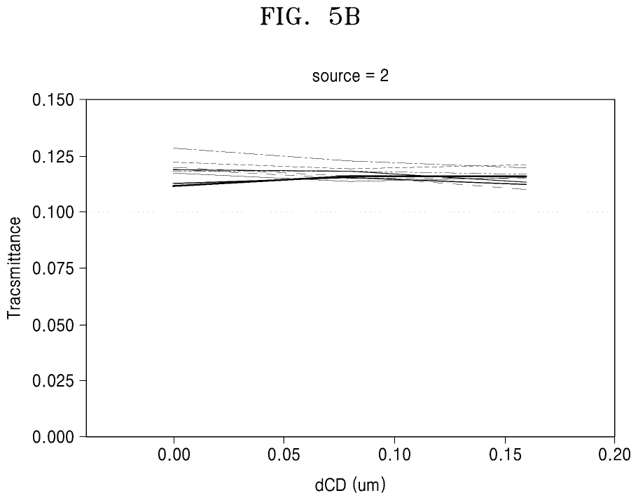

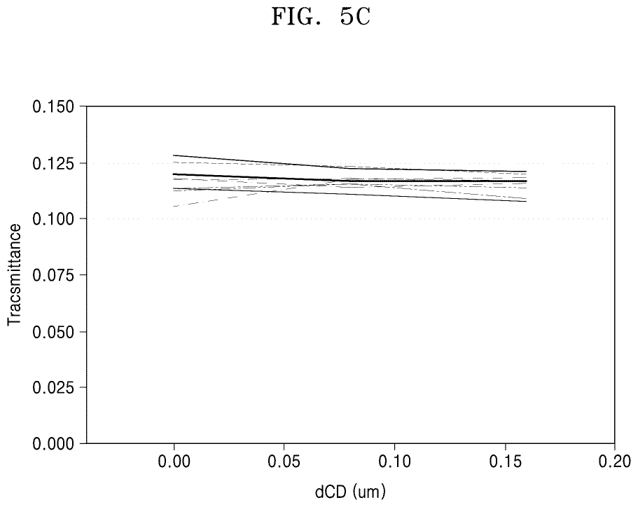

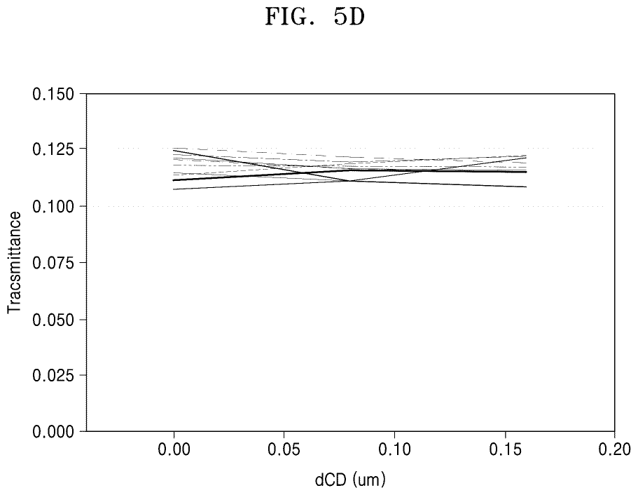

FIG. 4 is a diagram illustrating wavelength input and output by channel in an MMI 200, according to one or more embodiments. FIGS. 5A, 5B, 5C and 5D are graphs illustrating wavelength input and output by channel with respect to the pattern size of the MMI 200 shown in FIG. 4 according to one or more embodiments.

An input portion 120 of the MMI 200 may include a plurality of input channels. For example, referring to FIG. 4, the input portion 120 of the MMI 200 may include first to eighth input channels s1 to s8. For example, light having different wavelengths may be input into the first to eighth input channels s1 to s8. For example, light may be evenly distributed from each of the first to eighth input channels s1 to s8 to a plurality of output channels p1 to p8 of an output portion 130. For example, light may be evenly distributed to the output channels p1 to p8 from each of the first to eighth input channels s1 to s8 such that each of the output channels p1 to p8 may receive 12.5% of the light.

FIG. 5A is a graph illustrating how much light entering through the first input channel s1 is coupled to the output channels p1 to p8 in the cases in which the pattern size of the MMI 200 is equal to a reference length (dCD=0 μm), the pattern size increases by about 80 nm (dCD=about 0.08 μm), and the pattern size increases by about 160 nm (dCD=about 0.16 μm).

FIG. 5B is a graph illustrating how much light entering through the second input channel s2 is coupled to the output channels p1 to p8 in the cases in which the pattern size of the MMI 200 is equal to the reference length (dCD=0 μm), the pattern size increases by about 80 nm (dCD=about 0.08 μm), and the pattern size increases by about 160 nm (dCD=about 0.16 μm).

FIG. 5C is a graph illustrating how much light entering through the third input channel s3 is coupled to the output channels p1 to p8 in the cases in which the pattern size of the MMI 200 is equal to the reference length (dCD=0 μm), the pattern size increases by about 80 nm (dCD=about 0.08 μm), and the pattern size increases by about 160 nm (dCD=about 0.16 μm).

FIG. 5D is a graph illustrating how much light entering through the fourth input channel s4 is coupled to the output channels p1 to p8 in the cases in which the pattern size of the MMI 200 is equal to the reference length (dCD=0 μm), the pattern size increases by about 80 nm (dCD=about 0.08 μm), and the pattern size increases by about 160 nm (dCD=about 0.16 μm).

Referring to FIGS. 5A to 5D, it may be seen that even when the pattern size of the MMI 200 changes significantly, light distribution from each of the first to eighth input channels s1 to s8 to the output channels p1 to p8 remains at about 12.5% transmittance for each of the output channels p1 to p8, without significant variation.

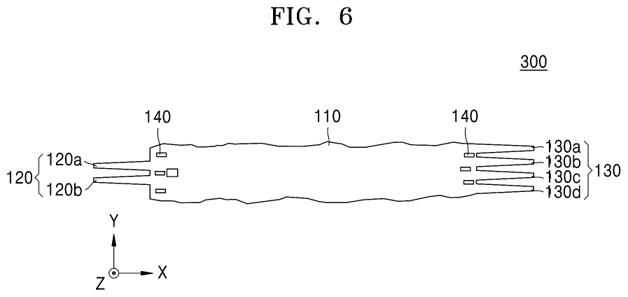

FIGS. 6 to 8 are diagrams illustrating MMIs 300, 400, and 500 according to one or more embodiments. The differences from those described with reference to FIG. 1 will now be mainly described, and in FIGS. 1 and 6 to 8, like reference numerals denote like elements.

Referring to FIGS. 6 to 8, in each of the MMIs 300, 400, and 500, the number of input waveguides 120a and 120b of an input portion 120 may be different from the number of output waveguides 130a, 130b, 130c, and 130d of an output portion 130.

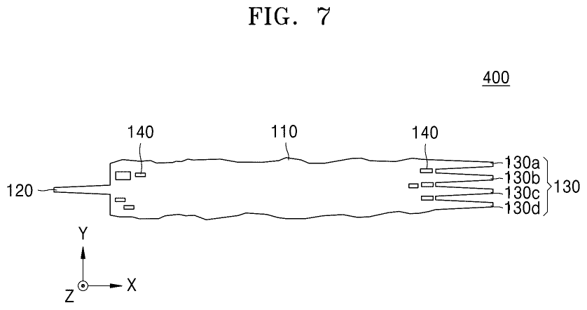

For example, referring to FIG. 6, the input portion 120 of the MMI 300 may include two input waveguides 120a and 120b, and the output portion 130 of the MMI 300 may include four output waveguides 130a, 130b, 130c, and 130d. Alternatively, referring to in FIG. 7, the input portion 120 of the MMI 400 may include one input waveguide 120a, and the output portion 130 of the MMI 400 may include four output waveguides 130a, 130b, 130c, and 130d.

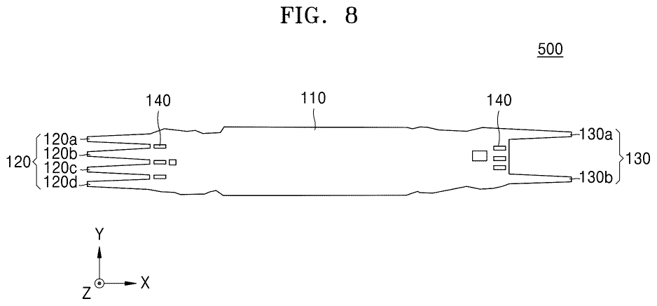

Alternatively, referring to FIG. 8, the input portion 120 of the MMI 500 may include four input waveguides 120a, 120b, 120c, and 120d, and the output portion 130 of the MMI 500 may include two output waveguides 130a and 130b. For example, light of different wavelengths may be input into the four input waveguides 120a, 120b, 120c, and 120d.

These are only examples, and the input portion 120 and the output portion 130 of each of the MMIs 300, 400, and 500 may have various structures.

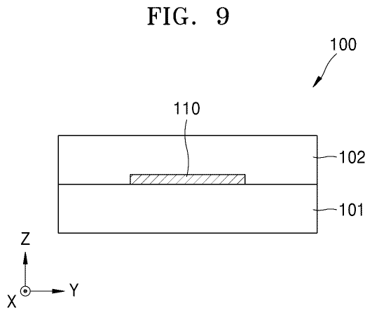

FIG. 9 is a cross-sectional view illustrating an MMI 100 according to one or more embodiments.

Referring to FIG. 9, the MMI 100 may further include lower cladding 101 provided below a multi-mode interference region 110, and upper cladding 102 provided above the multi-mode interference region 110.

The upper cladding 102 may include a material having a low refractive index. The upper cladding 102 may include a material having a lower refractive index than the refractive index of the multi-mode interference region 110. The upper cladding 102 may include, for example, silicon oxide. The upper cladding 102 may include, for example, SiO₂.

The lower cladding 101 may include a material having a low refractive index. The lower cladding 101 may include a material having a lower refractive index than the refractive index of the multi-mode interference region 110. The lower cladding 101 may include, for example, silicon oxide. The lower cladding 101 may include, for example, SiO₂. In addition, the material of the upper cladding 102 and the material of the lower cladding 101 may be the same or different from each other.

The multi-mode interference region 110 may include a material having a high refractive index. The multi-mode interference region 110 may include a material having a higher refractive index than the refractive index of the upper cladding 102. The multi-mode interference region 110 may include a material having a higher refractive index than the refractive index of the lower cladding 101. Light may propagate while being concentrated in the multi-mode interference region 110 including a material having a high refractive index. For example, the multi-mode interference region 110 may include at least one selected from silicon and silicon nitride. For example, the multi-mode interference region 110 may include at least one selected from silicon (Si) and SiNₓ.

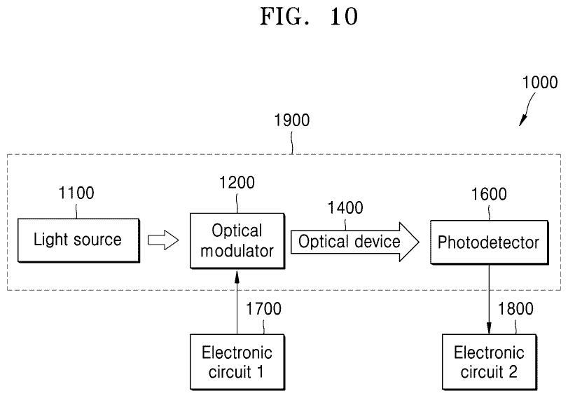

FIG. 10 is a diagram illustrating an example configuration of a photonic integrated circuit according to one or more embodiments.

Referring to FIG. 10, the photonic integrated circuit 1000 may include a light source 1100, an optical device 1400 configured to transmit light from the light source 1100, and a photodetector 1600 configured to convert the light transmitted through the optical device 1400 into an electrical signal. The optical device 1400 may include, in addition to a single waveguide, a splitter, a ring resonator, a grating coupler, or the like. The optical device 1400 may include any of the MMIs 100, 200, 300, 400, and 500 described above with reference to FIGS. 1 to 9.

The photonic integrated circuit 1000 may further include an optical modulator 1200 disposed in the optical device 1400, a first electronic circuit 1700 configured to apply a modulation signal to the optical modulator 1200, and a second electronic circuit 1800 to which an electrical signal generated by the photodetector 1600 is delivered.

The light source 1100, the optical modulator 1200, the optical device 1400, and the photodetector 1600 may be arranged on the same substrate 1900. The substrate 1900 may include a silicon substrate, and the photodetector 1600 may include a photodiode utilizing silicon semiconductor.

According to one or more embodiments, a multi-mode interferometer may include an input portion, an output portion, and a multi-mode interference region connecting the input portion and the output portion to each other, wherein the multi-mode interference region may include at least one cavity provided in a region adjacent to at least one of the input portion and the output portion.

The input portion may include at least one input waveguide, the multi-mode interference region may include the at least one cavity in a region adjacent to the input portion, and the at least one cavity may be apart from a central axis of the at least one input waveguide.

The input portion may include a plurality of input waveguides, the multi-mode interference region may include the at least one cavity in a region adjacent to the input portion, and the at least one cavity may be between central axes of adjacent input waveguides among the plurality of input waveguides.

The output portion may include at least one output waveguide, the multi-mode interference region may include the at least one cavity in a region adjacent to the output portion, and the at least one cavity may be apart from a central axis of the at least one output waveguide.

The output portion may include a plurality of output waveguides, the multi-mode interference region may include the at least one cavity in a region adjacent to the output portion, and the at least one cavity may be between central axes of adjacent output waveguides among the plurality of output waveguides.

Widths of adjacent portions of the multi-mode interference region may vary discontinuously in at least a part of the multi-mode interference region.

The input portion may include at least one input waveguide, and the output portion may include at least one output waveguide, wherein at least one of the at least one input waveguide and the at least one output waveguide may include a tapered structure.

The input portion may include at least one input waveguide, and the output portion may include at least one output waveguide, wherein a number of the at least one input waveguide may be equal to a number of the at least one output waveguide.

The input portion may include at least one input waveguide, and the output portion may include at least one output waveguide, wherein a number of the at least one input waveguide may be different from a number of the at least one output waveguide.

The output portion may include a plurality of output waveguides, and intensities of output light coupled to the plurality of output waveguides may be identical to each other.

The output portion may include a plurality of output waveguides, and intensities of output light coupled to the plurality of output waveguides may be different from each other.

The output portion may include a plurality of output waveguides, and wavelengths of output light coupled to the plurality of output waveguides may be identical to each other.

The output portion may include a plurality of output waveguides, and wavelengths of output light coupled to the plurality of output waveguides may be different from each other.

The multi-mode interference region may include at least one selected from silicon and silicon nitride.

The multi-mode interference region may be on lower cladding, and the lower cladding may include silicon oxide, wherein upper cladding may be on the multi-mode interference region, and the upper cladding may include silicon oxide.

According to one or more embodiments, a photonic integrated circuit may include a light source, a multi-mode interferometer configured to transmit light from the light source, and a photodetector configured to convert the light transmitted through the multi-mode interferometer into an electrical signal, wherein the multi-mode interferometer may include an input portion, an output portion, and a multi-mode interference region connecting the input portion and the output portion to each other, wherein the multi-mode interference region may include at least one cavity provided in a region adjacent to at least one of the input portion and the output portion.

The input portion may include at least one input waveguide, the multi-mode interference region may include the at least one cavity in a region adjacent to the input portion, and the at least one cavity may be apart from a central axis of the at least one input waveguide.

The input portion may include a plurality of input waveguides, the multi-mode interference region may include the at least one cavity in a region adjacent to the input portion, and the at least one cavity may be between central axes of adjacent input waveguides among the plurality of input waveguides.

The output portion may include at least one output waveguide, the multi-mode interference region may include the at least one cavity in a region adjacent to the output portion, and the at least one cavity may be apart from a central axis of the at least one output waveguide.

The output portion may include a plurality of output waveguides, the multi-mode interference region may include the at least one cavity in a region adjacent to the output portion, and the at least one cavity may be between central axes of adjacent output waveguides among the plurality of output waveguides.

Each of the embodiments provided in the above description is not excluded from being associated with one or more features of another example or another embodiment also provided herein or not provided herein but consistent with the disclosure.

According to the MMI and the photonic integrated circuit including the MMI of the disclosure, the wavelength characteristics of the MMI and the photonic integrated circuit may be maintained even when the overall pattern size of the MMI varies due to process errors. While the MMI and the photonic integrated circuit including the MMI have been described according to embodiments with reference to the accompanying drawings, it will be understood by those of ordinary skill in the art that the embodiments are merely examples, and various modifications and other equivalent embodiments may be made therein. Therefore, the embodiments described herein should be considered in a descriptive sense only and not for purposes of limitation. The scope of the disclosure is defined not by the above description but by the following claims, and all differences within equivalent ranges of the scope of the disclosure should be considered as being included in the scope of the disclosure.

What is claimed is:

1. A multi-mode interferometer comprising:
an input portion;
an output portion; and
a multi-mode interference region connected between the input portion and the output portion,
wherein the multi-mode interference region comprises at least one cavity corresponding to at least one of the input portion and the output portion.

2. The multi-mode interferometer of claim 1, wherein the input portion comprises at least one input waveguide,
wherein the at least one cavity is adjacent to the input portion, and
wherein the at least one cavity is spaced apart from a central axis of the at least one input waveguide.

3. The multi-mode interferometer of claim 1, wherein the input portion comprises a plurality of input waveguides,
wherein the at least one cavity is adjacent to the input portion, and
wherein the at least one cavity is between central axes of adjacent input waveguides among the plurality of input waveguides.

4. The multi-mode interferometer of claim 1, wherein the output portion comprises at least one output waveguide,
wherein the at least one cavity is adjacent to the output portion, and
wherein the at least one cavity is spaced apart from a central axis of the at least one output waveguide.

5. The multi-mode interferometer of claim 1, wherein the output portion comprises a plurality of output waveguides,
wherein the at least one cavity is adjacent to the output portion, and
wherein the at least one cavity is between central axes of adjacent output waveguides among the plurality of output waveguides.

6. The multi-mode interferometer of claim 1, wherein the multi-mode interference region extends in a first direction, and
wherein a width of the multi-mode interference region in a second direction perpendicular to the first direction varies along the first direction.

7. The multi-mode interferometer of claim 1, wherein the input portion comprises at least one input waveguide, and the output portion comprises at least one output waveguide, and
wherein at least one of the at least one input waveguide and the at least one output waveguide comprises a tapered structure.

8. The multi-mode interferometer of claim 1, wherein the input portion comprises at least one input waveguide, and the output portion comprises at least one output waveguide, and
wherein a number of the at least one input waveguide is equal to a number of the at least one output waveguide.

9. The multi-mode interferometer of claim 1, wherein the input portion comprises at least one input waveguide, and the output portion comprises at least one output waveguide, and
wherein a number of the at least one input waveguide is different from a number of the at least one output waveguide.

10. The multi-mode interferometer of claim 1, wherein the output portion comprises a plurality of output waveguides, and
wherein intensities of output light coupled to the plurality of output waveguides are the same.

11. The multi-mode interferometer of claim 1, wherein the output portion comprises a plurality of output waveguides, and
wherein intensities of output light coupled to the plurality of output waveguides are different.

12. The multi-mode interferometer of claim 1, wherein the output portion comprises a plurality of output waveguides, and
wherein wavelengths of output light coupled to the plurality of output waveguides are the same.

13. The multi-mode interferometer of claim 1, wherein the output portion comprises a plurality of output waveguides, and
wherein wavelengths of output light coupled to the plurality of output waveguides are different.

14. The multi-mode interferometer of claim 1, wherein the multi-mode interference region comprises at least one of silicon and silicon nitride.

15. The multi-mode interferometer of claim 1, further comprising a lower cladding and an upper cladding,
wherein the multi-mode interference region is on the lower cladding,
wherein the lower cladding comprises silicon oxide,
wherein the upper cladding is on the multi-mode interference region, and
wherein the upper cladding comprises silicon oxide.

16. A photonic integrated circuit comprising:
a light source configured to emit light;
a multi-mode interferometer configured to transmit light from the light source; and
a photodetector configured to convert the light transmitted through the multi-mode interferometer into an electrical signal,
wherein the multi-mode interferometer comprises:
an input portion;
an output portion; and
a multi-mode interference region connected between the input portion and the output portion, and
wherein the multi-mode interference region comprises at least one cavity corresponding to at least one of the input portion and the output portion.

17. The photonic integrated circuit of claim 16, wherein the input portion comprises at least one input waveguide,
wherein the at least one cavity is adjacent to the input portion, and
wherein the at least one cavity is spaced apart from a central axis of the at least one input waveguide.

18. The photonic integrated circuit of claim 16, wherein the input portion comprises a plurality of input waveguides,
wherein the at least one cavity is adjacent to the input portion, and
wherein the at least one cavity is between central axes of adjacent input waveguides among the plurality of input waveguides.

19. The photonic integrated circuit of claim 16, wherein the output portion comprises at least one output waveguide,
wherein the at least one cavity is adjacent to the output portion, and
wherein the at least one cavity is spaced apart from a central axis of the at least one output waveguide.

20. The photonic integrated circuit of claim 16, wherein the multi-mode interference region comprises a plurality of cavities comprising the at least one cavity,
wherein the multi-mode interference region comprises a first material having a first refractive index,
wherein a first cavity, among the plurality of cavities, is filled with a second material having a second refractive index, the second refractive index being less than the first refractive index, and
wherein a second cavity, among the plurality of cavities, is unfilled.
